(19) United States
(12) Patent Application Publication
(10) Pub. No.: US 2022/0363951 A1
(43) Pub. Date: Nov. 17, 2022

(54) ADHESIVE WALL MOUNT SYSTEMS CONFIGURED FOR SEQUENTIAL RELEASE OF ADHESIVE

(71) Applicant: The Hillman Group, Inc., Cincinnati, OH (US)

(72) Inventor: Byron K. GRICE, Phoenix, AZ (US)

(21) Appl. No.: 17/742,923

(22) Filed: May 12, 2022

Related U.S. Application Data
(60) Provisional application No. 63/187,702, filed on May 12, 2021.

(51) Int. Cl. C09J 7/20

(52) U.S. Cl. CPC C09J 7/203; C09J 2203/37

(57) ABSTRACT

An adhesive mounting system is configured such that segments of the adhesive system will sequentially release upon application of a pull force or other removal force.

### TECHNICAL FIELD

This application relates generally to wall mounting of objects and, more particularly, to adhesive wall mount systems that use of releasable adhesive structures.

### BACKGROUND

Various types of wall mount systems for hooks and other structures exist. Consumers often prefer to avoid placement of holes in walls, the need for tools and need for clean-up, but still desire strong wall mounts. The use of releasable adhesives for wall mount systems is known. For example, U.S. Pat. Nos. 5,516,581 and 6,231,962 describe a stretch release tape and U.S. Pat. No. 5,989,708 describes a hook assembly in combination with the stretch release tape. In such systems, objects are removed from a wall by pulling on a non-tacky area of the strip/tape, causing it to stretch and release from the wall. These systems suffer from drawbacks, such as a need to pull the strip slowly to avoid breakage and the tension on the strip causing the mounted object to snap back, hitting the knuckles, when the strip releases from the wall. The exposed strip pull tabs also tend to look unfinished. In addition, the adhered section of the wall surface (e.g., paper surface layer of drywall) can stay with the strip and be torn away from the wall when the strip is removed.

It would be desirable to provide a solution that addresses one or more of the above issue(s).

### SUMMARY

In one aspect, an adhesive mounting system includes an object to be mounted to a wall, the object including a wall facing side, and an adhesive system at the wall facing side of the object, the adhesive system including release means for sequentially releasing segments of the adhesive system from the wall.

In another aspect, a releasable adhesive mounting system includes a carrier, and a substrate structure positioned on the carrier, the substrate structure being elongated and following a serpentine pattern on the carrier, the substrate structure being adhesive along at least a majority of surface portions facing away from the carrier, wherein the serpentine pattern comprises a plurality of main segments arranged sequentially and interconnected by respective turn segments.

In a further aspect, a method of removably adhering an object to a wall surface involves: positioning a substrate structure on the object, where the substrate structure is elongated and follows a serpentine pattern on the carrier, the substrate structure including adhesive surface portions facing away from the object, wherein the serpentine pattern comprises a plurality of main segments arranged sequentially and interconnected by respective turn segments; adhering the object to the wall via the adhesive surface portions facing away from the object; and wherein the substrate structure includes a pull end part that, when pulled with sufficient force, causes the main segments to release from the wall in a sequential manner.

In yet another aspect, a releasable adhesive mounting system includes a carrier and a substrate structure positioned on the carrier, the substrate structure being elongated and following a non-linear pattern on the carrier, the substrate structure being adhesive along at least a majority of surface portions facing away from the carrier, wherein the substrate structure is configured such that a ratio of an adhesive width of the substrate structure to a full adhesive length of the substrate structure is less than 25%.

The details of one or more embodiments are set forth in the accompanying drawings and the description below. Other features, objects, and advantages will be apparent from the description and drawings, and from the claims.

### BRIEF DESCRIPTION OF THE DRAWINGS

FIGS. 1A-1C show one embodiment of an adhesive mounting system;

FIGS. 2A-2B show another embodiment of an adhesive mounting system;

FIGS. 3A-3C show a release operation of the adhesive mounting system;

FIGS. 4A-4G show another embodiment of an adhesive mounting system;

FIGS. 5A-5D show another embodiment of an adhesive mounting system;

FIGS. 6A-6C show another embodiment of an adhesive mounting system;

FIGS. 7A-7E show another embodiment of an adhesive mounting system;

FIGS. 8A-8C show another embodiment of an adhesive mounting system;

FIGS. 9A-9C show another embodiment of an adhesive mounting system;

FIGS. 10A-10C show another embodiment of an adhesive mounting system;

FIGS. 11A-11E show another embodiment of an adhesive mounting system;

FIGS. 12A-12C show another embodiment of an adhesive mounting system;

FIG. 13 shows another embodiment of an adhesive mounting system; and

FIG. 14 shows another embodiment of an adhesive mounting system.

### DETAILED DESCRIPTION

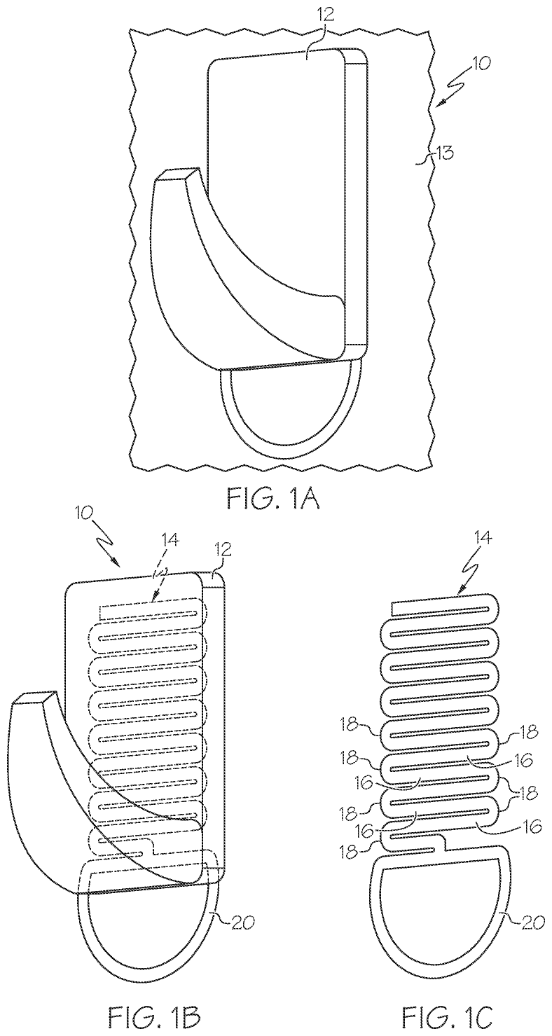

Referring to FIGS. 1A-1C, an adhesive wall mount system 10, here with a hook 12, uses an adhesive, on or as part of a substrate structure 14, formed in a way to sequentially detach small areas from the wall 13, while other areas remain adhered to the wall and continue to support an object on the wall surface by not simultaneous receiving the load from the removal process, until each of those other areas is in line to be removed. This configuration and method lowers the pull force needed to remove the substrate structure and lessens the chance of damaging the wall (e.g., less likely to cause the paper surface layer of drywall to tear away). Also, although the substrate structure may be formed of an elastomeric type material, there is no requirement that the adhesive structure be an elastomeric type material. For example, the substrate structure may be a foam material (e.g., polyurethane foam) that is adhesive on both a wall facing side and an object facing side (with the same or different levels of adhesion on the two sides). In the illustrated embodiment, the substrate structure is formed in a generally serpentine manner with main segments, here linear segments 16, connected by turn segments 18, and the sequential areas that are released are each linear segment 16 of the structure (e.g., beginning at the bottom and moving sequentially up). A pull ring structure 20 is also provided, but typically would not be adhesive in nature.

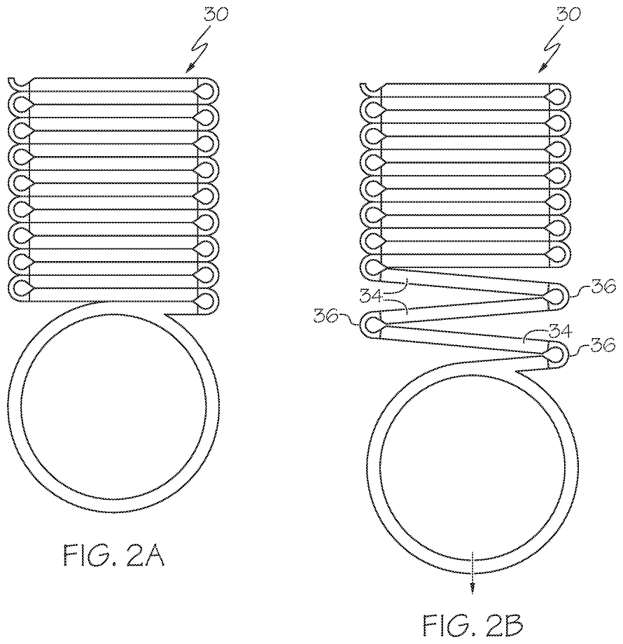

Referring to FIGS. 2A and 2B, an exemplary substrate structure or strip 30 with main segments 34 and turn segments 36 is shown, where FIG. 2A shows the installed state for object during mounting and FIG. 2B shows the initial stage of release via a pull force, per the arrow. In certain embodiments, advantage is obtained if the pull force is in a direction that is offset by thirty degrees or more from the long dimension (e.g., offset by thirty degrees or more from the left-right direction of the straight portions in FIG. 2A). The serpentine configuration enables peeling or separating a small surface area of the substrate structure away from the wall at a consistent rate, putting less load on the substrate structure 30. Here, the main segments 34 are formed as linear segments that are separated from the adhered surface(s) sequentially, rather than simultaneously. The substrate structure 30 can be made aesthetically pleasing, with the visible substrate structure pull 32 potentially having a unique design. When used with a clear object to be mounted (e.g., a clear fashion hook), the substrate structure body itself, or the manner in which the substrate structure is wrapped/wound, can be used to achieve a unique, desirable design.

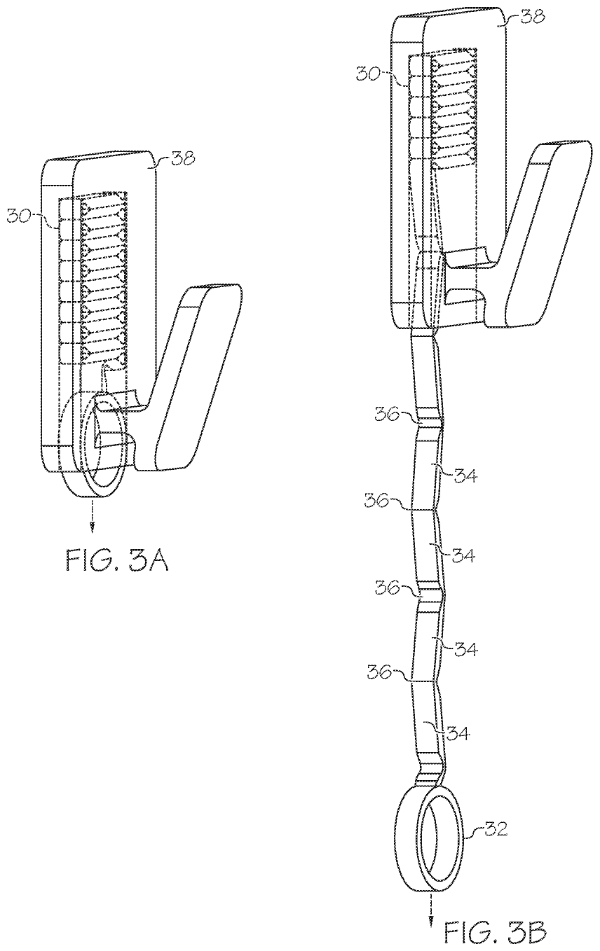

FIGS. 3A-3C further depict the exemplary sequential pull (aka zipper pull) release operation. As shown, the adhesive substrate structure 30 sequentially releases and pulls from the bottom of the object 38 while the object remains mounted, until full release is achieved per FIG. 3C.

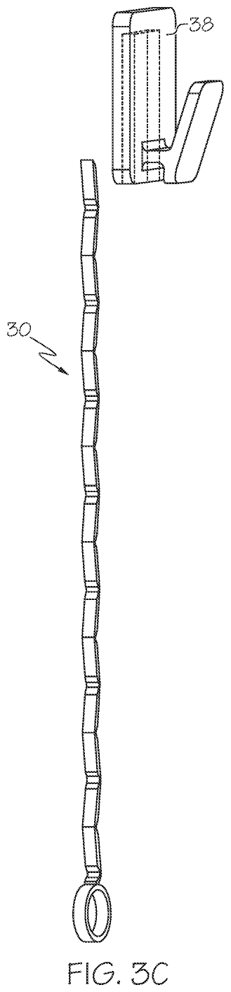

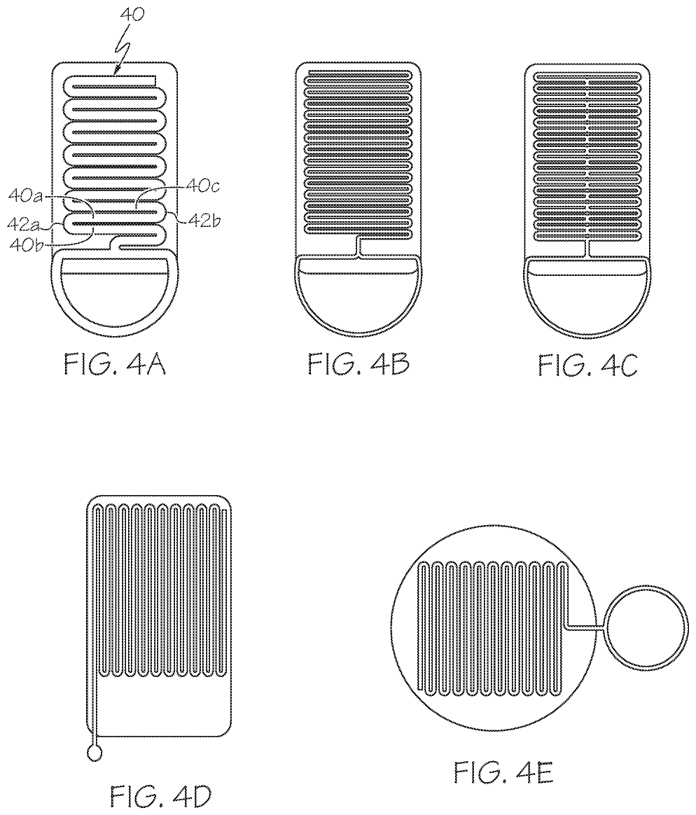

As reflected in FIGS. 4A-4G, numerous possible locations and styles for (i) substrate structure pulls, (ii) interconnection of substrate structure main segments and (iii) serpentine patterns for the substrate structure are possible. FIGS. 4A-4C show bottom pull for separation configurations (with linear substrate structure segments running horizontally on the object to be mounted), FIG. 4D shows a bottom to side pull for separation configuration (with linear substrate structure segments running vertically on the object to be mounted), FIG. 4E shows a side pull for separation configuration (with linear substrate structure segments running vertically on the object to be mounted) and FIGS. 4F and 4G show double side pull for separation configurations (with linear substrate structure segments running vertically on the object to be mounted).

FIGS. 4A, 4B, 4D, 4E and 4G show adhesive substrate structures with a streamer style separation configuration, in which each linear substrate structure segment 40 is interconnected at one end to an adjacent linear substrate structure segment by a single end turn and at the opposite end to another adjacent linear substrate structure segment by another single turn segment (e.g., linear segment 40a is connected to preceding linear segment 40b by turn segment 42a and linear segment 40a is connected to following linear segment 40c by turn segment 42b). In these configurations, the release or separation sequence, or part of the sequence, is first linear segment (beginning at a first end of the first linear segment and progressing toward the second end of the linear segment), first turn segment, second linear segment (beginning at the second end of the second linear segment and progressing toward the first end of the second linear segment), second turn segment, third linear segment etc.

FIGS. 4C and 4F show adhesive substrate structures with an accordion style separation configuration, in which pairs 50 of adjacent substrate structure linear segments 52 are connected at both ends by turn segments 54 to form continuous loops, and each looped pair 50 is connected to the next looped pair by a transverse joining segment 56 (here at the midpoint along the pair length). In these configurations, the release or separation sequence, or part of the sequence, is first linear segment of a first looped pair (beginning in the middle and progressing to both ends), both turn segments of the first looped pair, second linear segment of the first looped pair (beginning at the ends and progressing toward the middle), joining segment, first linear segment of the second looped pair (beginning in the middle and progressing to both ends), both turn segments of the second looped pair, second linear segment of the second looped pair (beginning at the ends and progressing toward the middle), etc. In either the streamer style configuration separation configuration or the accordion style separation configuration, the turn segments could be formed without any adhesive, but including adhesive is also possible.

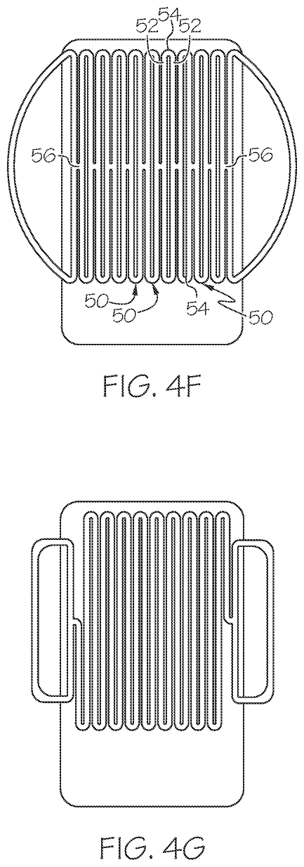

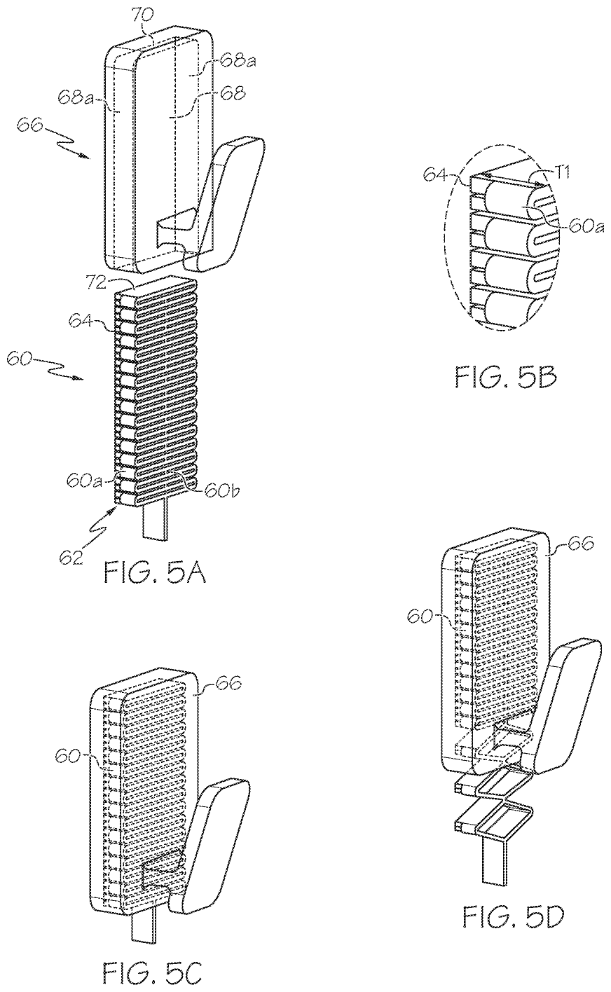

Referring now to FIGS. 5A-5D, in one embodiment, the adhesive substrate structure 60 is mechanically connected to the object and only one side 62 of the substrate structure includes surface portions with adhesive 64. The object 66 to be mounted includes a rear mount slot 68 in which the substrate structure 60 is captured. The rear mount slot 68 is open at the back, to allow the adhesive 64 to engage the wall surface, and the rear mount slot 68 includes inwardly extending vertically running lips 68a. The turn segments 60a of the substrate structure extend laterally beyond the linear segments 60b of the substrate structure and interact with the lips 68a to prevent the object 66 from pulling away from the substrate structure in a direction outward from the wall surface to which it is attached. The adhesive 64 is on the linear segments 60b, but not the turn segments 60a. The top wall 70 of the slot engages the top 72 of the substrate structure so that the object is supported when the substrate structure is adhered to a wall surface at side 62. In this embodiment, each linear segment of the substrate structure engages the adjacent linear segments of the substrate structure (at top and bottom) so that the downward force of the object on the substrate structure is transferred to all of the linear segments so that all segments contribute to the support of the object. In this configuration, a thickness T1 of the substrate structure 60 may be on the order of between about 2 mm and about 6 mm to provide adequate structural interaction with the top wall 70 of the slot. In this embodiment, the substrate structure is preferably rigid or semi-rigid and could be formed of cast or extruded material (e.g. polymer or other) and the adhesive could be a PSA (pressure sensitive adhesive). Per FIG. 5D, the substrate structure 60 is configured to provide an accordion style separation from the wall surface when the free end of the substrate structure is pulled downward.

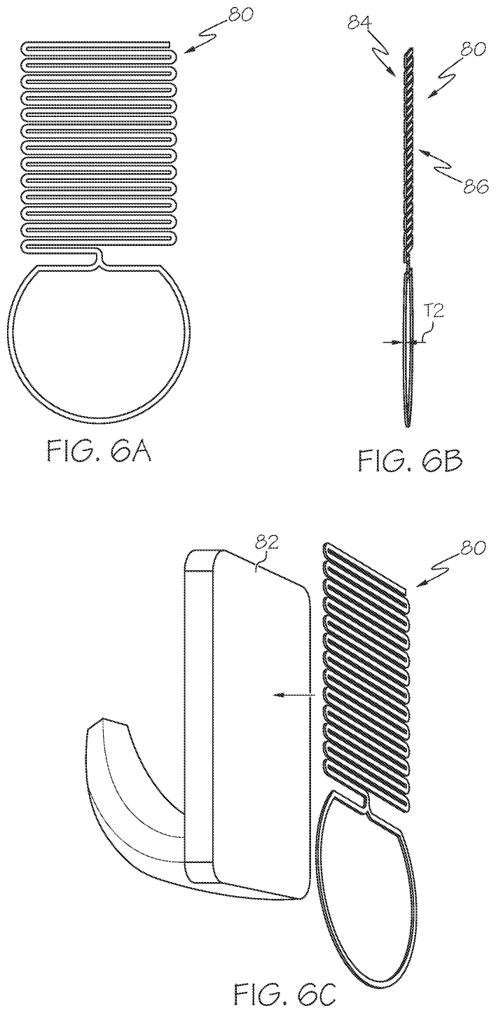

Referring now to FIGS. 6A-6D, in another embodiment, the substrate structure 80 may also be adhesively bonded to the object 82 to be mounted, such as where both sides 84 and 86 of the substrate structure include adhesive or where the adhesive is distributed throughout the substrate structure material. This arrangement permits a substrate structure of smaller thickness T2 to be used, such as a thickness of between about 0.1 mm and about 1.00 mm (e.g., about 0.1 mm to about 0.8 mm). This embodiment can also be used with relatively thin objects, such as posters. In this embodiment, the substrate structure could be formed of cast or extruded material (e.g. polymer or other) and the adhesive could be a PSA, or the substrate structure could be an elastomer with adhesive properties throughout the material. In the case of such an elastomer substrate, in embodiments, the substrate structure may have a thickness of at least 1.12 mm or more, such as at least 1.25 mm or at least 1.40 mm (e.g., between 1.14 mm and 1.65 mm). In various embodiments, a density of the substrate structure is at least 200 kg/cm³, such as at least 220 kg/cm³ or at least 240 kg/cm³, but variations below 200 kg/cm³ are also possible, particularly where a foam material is used.

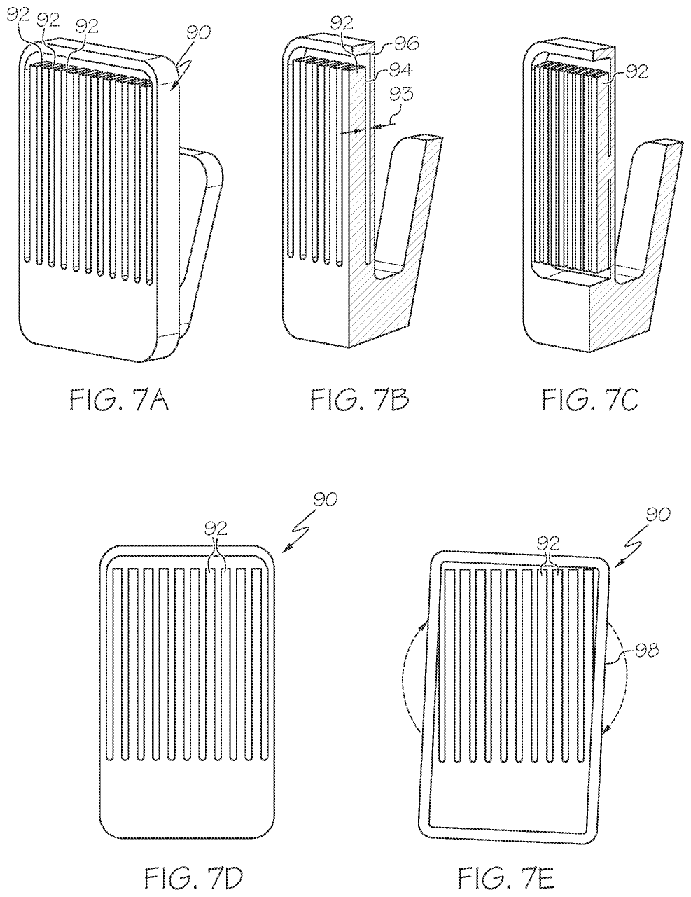

Referring to FIGS. 7A-7E, a twist to release embodiment includes and object 90 with integrated parallel fingers 92 that float and can therefore flex. The fingers can flex because the forward facing sides 94 of the fingers are not attached to the front wall surface 96 of the object 90 (FIG. 7B), due to a small gap 93 therebetween, or are only attached to the front wall surface along a short extend (FIG. 7C). In operation, the object can be twisted in a circular motion for removal. Because each inside vertical finger 92 is only attached to the rest of the object at one small section (the end section per FIG. 7B or a mid-section per FIG. 7C), when the object 90 is twisted, per FIG. 7E, the outside wall 98 of the object hits one individual finger 92 causing it to release and move into contact with the next finger, and so on, in sequential order, releasing each finger from the wall one at a time. Adhesive can be applied directly on fingers 92 so as to stay with the object 90 when the object is removed from the wall. Another option is an object and substrate style in which the object comes off of the adhesive substrate when twisted and the adhesive substrate is then peeled from the wall.

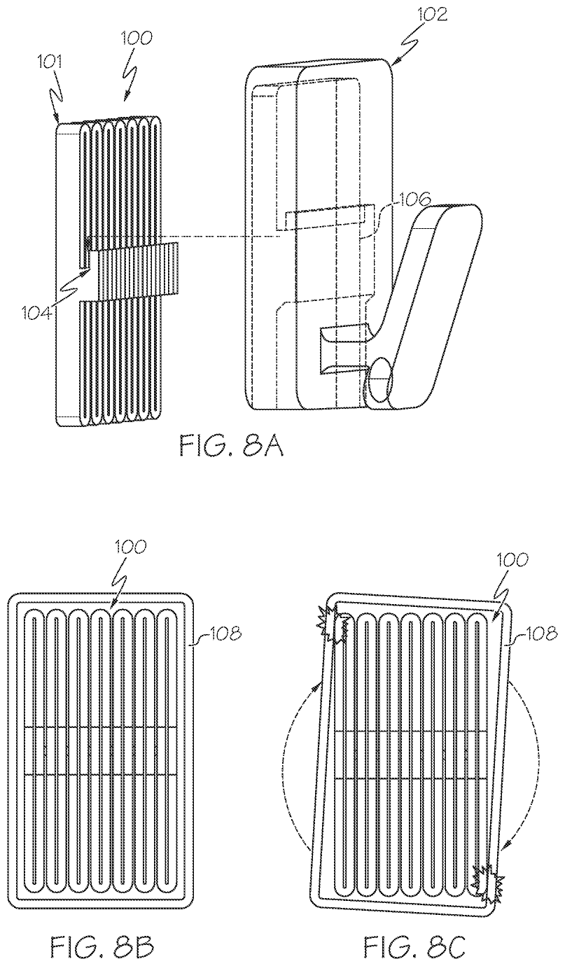

FIGS. 8A-8C depict another twist to release embodiment in which the substrate structure 100 is formed separately from, and then connected to, the object 102 to be mounted. The adhesive structure 100 includes adhesive only at its rear (wall facing) side 101, and has forward facing hooks 104 that engage with a recessed slot 106 at the back side of the object 102. Rotation of the object 102 causes the outer side walls 108 of the object to engage and release the end segments of the adhesive structure, which in turn engage and effect release of next segments in a sequential manner.

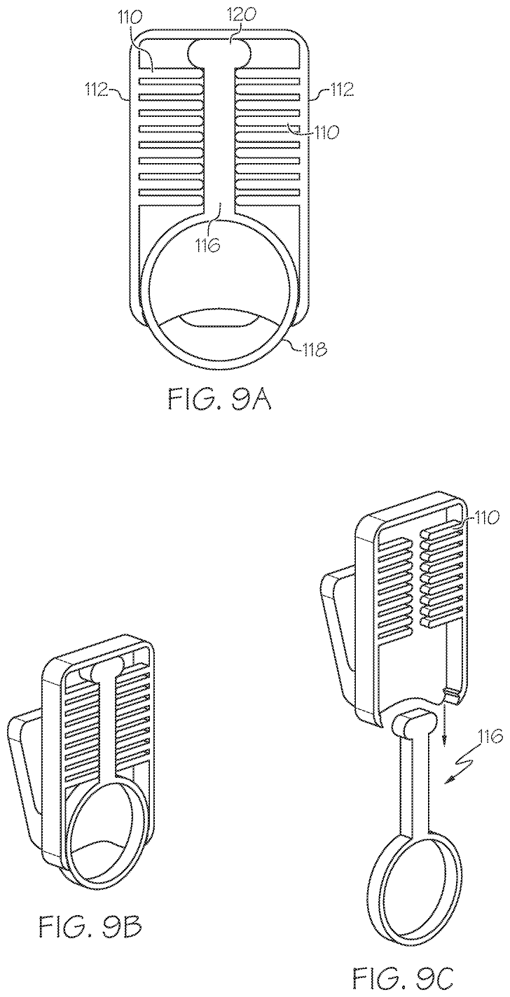

FIGS. 9A-9C depict a plow style release configuration in which parallel fingers 110 at the back side of the object have ends that are connected to walls 112 of the object 114 to be supported. The rear facing or wall facing side of the fingers includes applied adhesive. A release member 116 includes a pull ring 118 and an end bar 120 that sequentially engages the fingers 110 when pulled downward for the purpose of release. The plow style release configuration does not use a streamer or accordion style strip. The sequential fingers 110 are attached to the object 102, but not the release member 116. The only adhesive would be on the object fingers, none on the release member 116. The release member 116 is mechanically captivated in the back recess of the object until removed for the purpose of releasing the object from the wall. The plow style configuration could also be implemented with fingers running vertically.

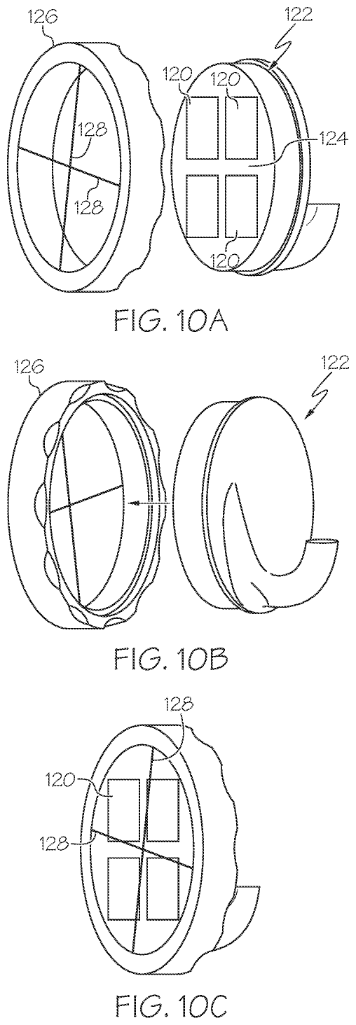

FIGS. 10A-10E depict a slice to release configuration in which distinct adhesive regions 120 at the rear side of an object 122 to be supported are separated from each other by gaps 124. The object 122 fits within an outer ring unit 126 that includes release wires 128 adjacent the wall. Rotation of the outer ring unit 126 causes the release wires 128 to sequentially move between the wall surface and the adhesive regions 120 to release the adhesive from the wall. The adhesive regions 124 may be individual adhesive substrates that are also adhesively secured to the rear side of the object 122. The wires could initially be located in the gaps 124 when the object is wall mounted, or the wires could initially be captured beneath edge regions of the adhesive.

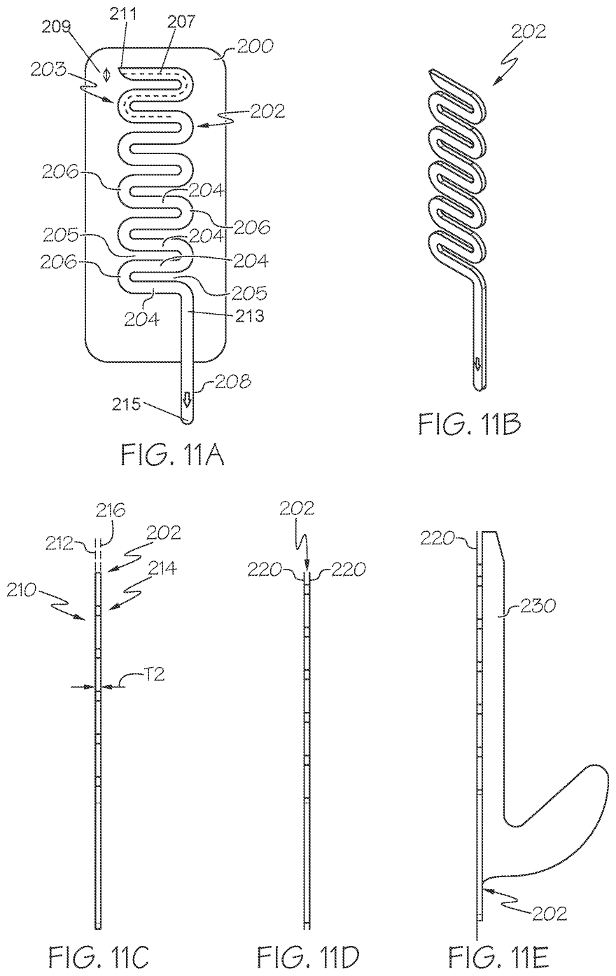

Referring now to FIGS. 11A-11C, a releasable adhesive mounting system includes a carrier 200 and a substrate structure 202 positioned on the carrier 200. The substrate structure 200 is elongated and follows a serpentine pattern 203 on the carrier. The substrate structure is adhesive along at least a majority of surface portions facing away from the carrier. The serpentine pattern 203 includes a plurality of main segments 204 arranged sequentially and interconnected by respective turn segments 206. The serpentine pattern 203 forms the main portion of the substrate structure 202, and the substrate structure 202 includes a free end 208 extending away from the main portion to facilitate grasping of the free end during a release operation.

The substrate structure 202 is configured with a first major side 210 lying substantially in a first plane 212, the first major side including the surface portions that face away from the carrier. The substrate structure is configured with a second major side 214 lying substantially in a second plane 216 that runs substantially parallel to the first plane 212. Surface portions forming the second major side 214 are also adhesive, wherein the second major side 214 lies in adhesive contact with the carrier 200.

In one embodiment, the substrate structure 202 is formed of an elastomeric material with adhesive properties throughout the elastomeric material, such that all surface portions of the substrate structure 202 have an adhesive property. In such an embodiment, for each main segment 204, the main segment is spaced apart from any preceding main segment by a gap 205 and the main segment is spaced apart from any following main segment by a gap 205, such that surfaces of the main segment are not adhesively bonded to any preceding main segment or any following main segment. This configuration facilitates the sequential release of the main segments.

In one embodiment, per FIG. 11D, the carrier may be formed by a thin sheet material 220 (e.g., a liner paper or liner film/plastic) with a release surface on which the substrate structure 202 is positioned and from which the substrate structure is releasable for facilitating application of the substrate structure 200 to a wall surface or to a surface of an object to be supported on a wall. In such an embodiment, the substrate structure 202 may be positioned between two such release sheets 220, such as for the purposes of shipping and handling prior to use. In such an embodiment, the end user removes one release sheet 210 to apply the substrate structure adhesively onto one of a wall or an object to be mounted, and then removes the other release sheet to apply the substrate structure adhesively on to the other of the wall or the object to be mounted.

In another embodiment, per FIG. 11E, the carrier 200 is formed by an object, such as a hook 230, to be supported on a wall, and the substrate structure 200 is adhesively secured to the wall facing side of the object. In such an embodiment, the wall facing major side of the substrate structure may be covered by a release sheet 220 to facilitate shipping and handling prior to mounting the object to a wall.

In embodiments, a thickness T2 of the substrate structure 202 between the first major side 210 and the second major side 214 may be in the range of 0.1 mm to 1.0 mm. However, other variations are possible.

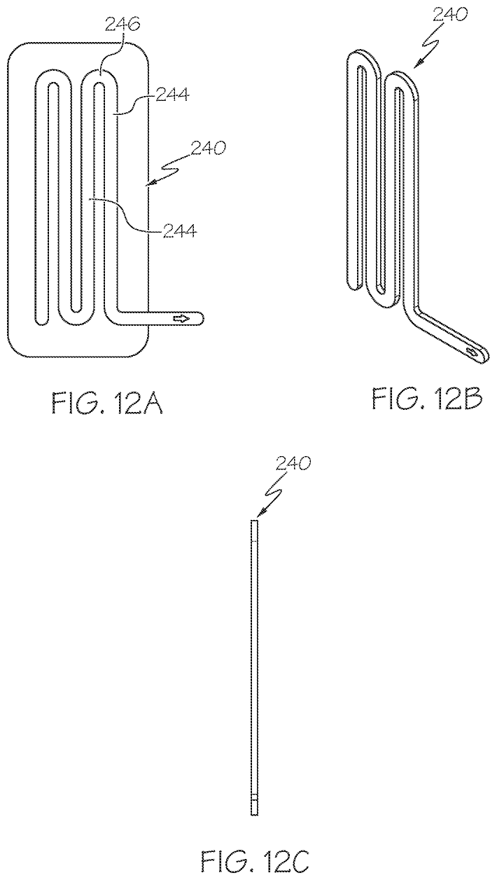

The embodiment(s) of FIGS. 11A-11E contemplate the main segments of the substrate structure running in a side to side direction relative to the object to be mounted. In an alternative configuration shown in FIGS. 12A-12C, the substrate structure 240 is configured with its main segments 244 running vertically on the object to be mounted, and turn segments located at the top and bottom of the serpentine pattern.

The above-described embodiments provide a method of removably adhering an object to a wall surface, where the method involves positioning a substrate structure on the object, where the substrate structure is elongated and follows a serpentine pattern on the carrier, the substrate structure including adhesive surface portions facing away from the object, wherein the serpentine pattern comprises a plurality of main segments arranged sequentially and interconnected by respective turn segments; adhering the object to the wall via the adhesive surface portions facing away from the object; and wherein the substrate structure includes a pull end part that, when pulled with sufficient force, causes the main segments to release from the wall in a sequential manner.

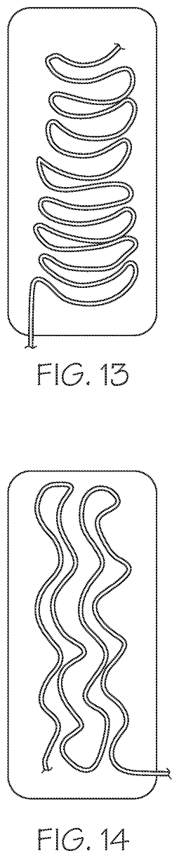

While the embodiments described above contemplate substrate structures in which the main segments are linear, other serpentine configurations are possible, such as a serpentine configuration which follows a sawtooth pattern, a serpentine configuration in which the main segments are arcuate, or otherwise curved, per FIG. 13, or a serpentine configuration in which the main segments follow a wave pattern, per FIG. 14.

All of the serpentine configurations described above facilitate sequential release by preventing the applied pulling force to achieve release from being simultaneously applied to the full length of the substrate structure. However, other aspects of the system also facilitate release, and can enable advantageous results even in the case of non-linear patterns that are not serpentine in nature (e.g., a circular pattern, where release is achieved pulling while rotating in a circle).

For example, one aspect that facilitates the sequential release is the relatively narrow configuration of the adhesive substrate structure, as compared to the full adhesive length of the substrate structure (e.g., where the full adhesive length is defined as the length of an imaginary line 207 (FIG. 11A) that runs along the mid-point of the width 209 of the substrate structure, from end location 211 to the location (e.g., such as location 213 in a case where the adhesive does not extend to the end, or location 215 in a case where the entire length is adhesive) where the adhesive properties end). Embodiments in which the ratio of the adhesive width to full adhesive length of the substrate structure are less than 25% are preferred, with a ratio of less than 20% more preferred, a ratio of less than 15% even more preferred, a ratio of less than 10% still even more preferred and a ratio of less than 5% further preferred.

Another aspect that that facilitates the sequential release of various of the embodiments is a relatively low adhesive width to adhesive length ratio for each lineal segment of the serpentine pattern. Embodiments in which the ratio of the adhesive width to adhesive length of the straight segments of substrate structure is less than 25% are preferred.

With respect to the releasable nature of the adhesive mounting system, in some embodiments, a pull force of no more than ten pounds, where the pull force is in a direction substantially parallel to the wall surface (e.g., in a direction that is offset at an angle of no more ten degrees, preferably as no more than five degrees, relative to the wall surface), may be considered advantageous. But other pull force variations are possible.

It is to be clearly understood that the above description is intended by way of illustration and example only, is not intended to be taken by way of limitation, and that other changes and modifications are possible.

What is claimed is:

1. A releasable adhesive mounting system, comprising:
a carrier;
a substrate structure positioned on the carrier, the substrate structure being elongated and following a serpentine pattern on the carrier, the substrate structure being adhesive along at least a majority of surface portions facing away from the carrier, wherein the serpentine pattern comprises a plurality of main segments arranged sequentially and interconnected by respective turn segments.

2. The releasable adhesive mounting system of claim 1, wherein the substrate structure is configured with a first major side lying substantially in a first plane, the first major side including the surface portions that face away from the carrier, wherein the substrate structure is configured with a second major side lying substantially in a second plane that runs substantially parallel to the first plane, wherein surface portions forming the second major side are adhesive, wherein the second major side lies in adhesive contact with the carrier.

3. The releasable adhesive mounting system of claim 1, wherein the carrier comprises a release surface on which the substrate structure is positioned and from which the substrate structure is releasable for facilitating application of the substrate structure to a wall surface or to a surface of an object to be supported on a wall.

4. The releasable adhesive mounting system of claim 1, wherein the carrier comprises an object to be supported on a wall or a foam material.

5. The releasable adhesive mounting system of claim 1, wherein the substrate structure comprises an elastomeric material with adhesive properties throughout the elastomeric material, such that all surface portions of the substrate structure have an adhesive property.

6. The releasable adhesive mounting system of claim 1, wherein a thickness of the substrate structure between the first major side and the second major side is in the range of 0.1 mm to 1.65 mm.

7. The releasable adhesive mounting system of claim 1, wherein, for each main segment, the main segment is spaced apart from any preceding main segment by a gap and the main segment is spaced apart from any following main segment by a gap, such that surfaces of the main segment are not adhesively bonded to any preceding main segment or any following main segment.

8. The releasable adhesive mounting system of claim 1, wherein the serpentine pattern comprises a main portion of the substrate structure, and the substrate structure includes a free end extending away from the main portion to facilitate grasping of the free end during a release operation.

9. The releasable adhesive mounting system of claim 1, wherein the serpentine pattern comprises a main portion of the substrate structure, and the substrate structure comprises a pull-ring portion extending away from the main portion to facilitate grasping of the pull-ring portion during a release operation.

10. The releasable adhesive mounting system of claim 2, wherein the carrier comprises a mounted object, wherein second major side is adhered to a wall surface.

11. A method of removably adhering an object to a wall surface, comprising:
positioning a substrate structure on the object, where the substrate structure is elongated and follows a serpentine pattern on the carrier, the substrate structure including adhesive surface portions facing away from the object, wherein the serpentine pattern comprises a plurality of main segments arranged sequentially and interconnected by respective turn segments;
adhering the object to the wall via the adhesive surface portions facing away from the object; and
wherein the substrate structure includes a pull end part that, when pulled with sufficient force, causes the main segments to release from the wall in a sequential manner.

12. The method of claim 11, wherein, for each main segment, the main segment is spaced apart from any preceding main segment by a gap and the main segment is spaced apart from any following main segment by a gap, such that surfaces of the main segment are not adhesively bonded to any preceding main segment or any following main segment.

13. The method of claim 11, wherein the substrate structure is configured with a first major side lying substantially in a first plane, the first major side including the adhesive surface portions that face away from the object, wherein the substrate structure is configured with a second major side lying substantially in a second plane that runs substantially parallel to the first plane, wherein surface portions forming the second major side are adhesive, wherein the second major side lies in adhesive contact with the object.

14. An adhesive mounting system, comprising:
an object to be mounted to a wall, the object including a wall facing side;
an adhesive system at the wall facing side of the object, the adhesive system including release means for sequentially releasing segments of the adhesive system from the wall.

15. The adhesive mounting system of claim 14, wherein the adhesive system comprises an adhesive structure having a forward facing side adhesively secured to the object and a wall facing side for adhesive securement to the wall.

16. The adhesive mounting system of claim 14, wherein the adhesive system comprises an adhesive structure having a non-adhesive forward facing side, the adhesive structure mechanically engaged with the object, and a wall facing side that is adhesive for adhesive securement to the wall.

17. The adhesive mounting system of claim 14, wherein the adhesive system comprises an adhesive structure with multiple parallel linear segments.

18. The adhesive mounting system of claim 17, wherein each parallel linear segment is connected to one adjacent parallel linear segment by one end turn segment and to another parallel linear segment by another end turn segment.

19. The adhesive mounting system of claim 17, wherein pairs of adjacent parallel linear segments are connected together by end turn segments to form looped pairs.

20. The adhesive mounting system of claim 18, wherein the adhesive structure includes a grippable free end for applying a pull force to effect the sequential release.

21. The adhesive mounting system of claim 17, wherein each parallel linear segment is integrally connected to the object by one end and includes a free end, such that the linear segment is capable of flexing relative to a main body of the object.

22. The adhesive mounting system of claim 17, wherein each parallel linear segment is integrally connected to the object by a middle segment and includes opposite free ends, such that the linear segment is capable of flexing relative to a main body of the object.

23. The adhesive mounting system of claim 17, wherein one or more wires are positioned for movement along the wall facing side.

24. The adhesive mounting system of claim 1, wherein the substrate structure is configured such that a ratio of an adhesive width of the substrate structure to a full adhesive length of the substrate structure is less than 25%.

25. The releasable adhesive mounting system of claim 24, wherein the substrate structure is configured such that the ratio is less than 20%.

26. The releasable adhesive mounting system of claim 24, wherein the substrate structure is configured such that the ratio is less than 15%.

27. The releasable adhesive mounting system of claim 24, where the substrate structure is configured such that the ratio is less than 10%.

28. A releasable adhesive mounting system, comprising:
a carrier;
a substrate structure positioned on the carrier, the substrate structure being elongated and following a non-linear pattern on the carrier, the substrate structure being adhesive along at least a majority of surface portions facing away from the carrier, wherein the substrate structure is configured such that a ratio of an adhesive width of the substrate structure to a full adhesive length of the substrate structure is less than 25%.

29. The releasable adhesive mounting system of claim 28, wherein the substrate structure is configured such that the ratio is less than 20%.

30. The releasable adhesive mounting system of claim 28, wherein the substrate structure is configured such that the ratio is less than 15%.

31. The releasable adhesive mounting system of claim 28, where the substrate structure is configured such that the ratio is less than 10%.

32. The releasable adhesive mounting system of claim 28, wherein at least part of the non-linear pattern is a serpentine pattern.
